(19) United States
(12) Patent Application Publication
(10) Pub. No.: US 2026/0350744 A1
(43) Pub. Date: Nov. 5, 2026

(54) MODEL GENERATION APPARATUS, CONVERSION APPARATUS, AND MODEL GENERATION METHOD

(71) Applicant: NEC Corporation, Tokyo (JP)

(72) Inventors: Masayuki ARIYOSHI, Tokyo (JP); Toshiyuki NOMURA, Tokyo (JP); Shingo YAMANOUCHI, Tokyo (JP)

(73) Assignee: NEC Corporation, Tokyo (JP)

(21) Appl. No.: 19/488,902

(22) PCT Filed: May 31, 2024
(86) PCT No.: PCT/JP2024/020010

§ 371 Date: Dec. 1, 2025

(30) Foreign Application Priority Data
Jun. 9, 2023 (JP) 2023-095343

(51) Int. Cl. G06T 3/4046; G01S 13/89

(52) U.S. Cl. CPC G06T 3/4046; G01S 13/89

(57) ABSTRACT

This model generation device comprises a training unit. The training unit generates a model by performing machine learning by using a first image and a second image. The first image is an image generated by using first radar signal data. The second image is an image generated by using second radar signal data. The first radar signal data is a signal extracted from the second radar signal data.

### TECHNICAL FIELD

The present invention relates to a model generation apparatus, a conversion apparatus, a model generation method, and a program.

### BACKGROUND ART

A radar makes it possible to transmit and receive radio waves to and from a target and obtain an image of the target.

PTL 1 describes a technique for determining a possibility that a target person possesses a dangerous object using a radar. Furthermore, PTL 1 describes that secondary screening is performed using a radar capable of detecting with higher accuracy than primary screening.

### CITATION LIST

### Patent Literature

PTL 1: JP 2022-164899 A

### SUMMARY OF INVENTION

### Technical Problem

However, in PTL 1 described above, resolution of an image obtained by a radar depends on the number of antennas and a frequency of the radar.

In view of the above problem, an example object of the present invention is to provide a model generation apparatus, a conversion apparatus, a model generation method, and a program capable of obtaining a high-resolution image regardless of an antenna configuration of a radar.

### Solution to Problem

According to one example aspect of the present invention,
provided is a model generation apparatus including a learning means for generating a model by performing machine learning using a first image and a second image,
wherein the first image is an image generated using first radar signal data,
the second image is an image generated using second radar signal data, and
the first radar signal data is a signal extracted from the second radar signal data.

According to one example aspect of the present invention,
provided is a conversion apparatus including a conversion means for converting a target image using a model generated by the model generation apparatus.

According to one example aspect of the present invention,
provided is a model generation method including generating, by one or more computers, a model by performing machine learning using a first image and a second image,
wherein the first image is an image generated using first radar signal data,
the second image is an image generated using second radar signal data, and
the first radar signal data is a signal extracted from the second radar signal data.

According to one example aspect of the present invention,
provided is a conversion method including converting, by one or more computers, a target image using the model generated by the model generation apparatus.

According to one example aspect of the present invention,
provided is a computer-readable recording medium on which a program is recorded, the program causing a computer to function as a learning means for generating a model by performing machine learning using a first image and a second image,
wherein the first image is an image generated using first radar signal data,
the second image is an image generated using second radar signal data, and
the first radar signal data is a signal extracted from the second radar signal data.

### Advantageous Effects of Invention

According to one example aspect of the present invention, it is possible to provide the model generation apparatus, the conversion apparatus, the model generation method, and the program capable of obtaining a high-resolution image regardless of an antenna configuration of a radar.

### BRIEF DESCRIPTION OF DRAWINGS

FIG. 1 It is a diagram illustrating an outline of a model generation device according to a first example embodiment.

FIG. 2 It is a diagram illustrating a model generated by the model generation device according to the first example embodiment.

FIG. 3 It is a diagram for describing a first image and a second image according to the first example embodiment.

FIG. 4 It is a diagram illustrating an antenna arrangement in one subset.

FIG. 5 It is a diagram illustrating a first modified example of the antenna arrangement in one subset.

FIG. 6 It is a diagram illustrating a second modified example of the antenna arrangement in one subset.

FIG. 7 It is a diagram illustrating a functional configuration of the model generation device according to the first example embodiment.

FIG. 8 It is a diagram illustrating a computer for achieving the model generation device.

FIG. 9 It is a diagram illustrating an outline of a model generation method according to the first example embodiment.

FIG. 10 It is a diagram illustrating a functional configuration of a model generation device according to a first modification.

FIG. 11 It is a diagram for describing a first image and a second image according to a second example embodiment.

FIG. 12 It is a diagram illustrating a model generated by a model generation device according to a third example embodiment.

FIG. 13 It is a diagram illustrating an outline of a conversion device according to a fourth example embodiment.

FIG. 14 It is a diagram illustrating a functional configuration of the conversion device according to the fourth example embodiment.

FIG. 15 It is a diagram illustrating an outline of a conversion method according to the fourth example embodiment.

### EXAMPLE EMBODIMENT

Hereinafter, example embodiments of the present invention will be described with reference to the drawings. In all the drawings, the same components are denoted by the same reference signs, and description thereof will be omitted as appropriate.

### First Example Embodiment

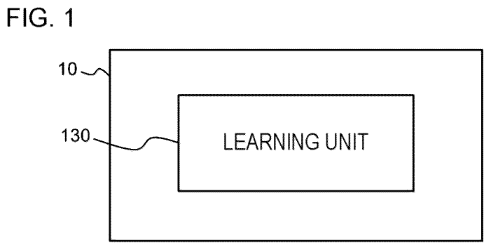

FIG. 1 is a diagram illustrating an outline of a model generation device 10 according to a first example embodiment. The model generation device 10 includes a learning unit 130. The learning unit 130 generates a model by performing machine learning using a first image and a second image. The first image is an image generated using first radar signal data. The second image is an image generated using second radar signal data. The first radar signal data is a signal extracted from the second radar signal data.

According to the model generation device 10, a model capable of obtaining a high-resolution image is obtained regardless of an antenna configuration of a radar.

Hereinafter, a detailed example of the model generation device 10 will be described.

In a radar that transmits and receives radio waves through a plurality of antennas, resolution of an obtained image usually depends on an antenna configuration. Specifically, the higher a frequency f of the radio wave transmitted and received by each of the antennas (or the wider a frequency band), the higher the resolution of the obtained image. Furthermore, the larger the number of antennas included in the radar, the higher the resolution of the obtained image. In the radar, the plurality of antennas are usually arranged at predetermined intervals (for example, λ/2) based on a wavelength λ of the radio wave transmitted and received by each of the antennas. Therefore, in a case where an aperture size is constant, the number of antennas increases as the frequency f is higher.

Here, for example, in a case where the aperture size of the radar is reduced for downsizing, the number of antennas that can be included in the radar is reduced. In addition, for example, it is conceivable to reduce the number of antennas in order to reduce manufacturing cost of the radar. Therefore, a technique capable of obtaining a high-resolution image even with a radar including a small number of antennas is advantageous.

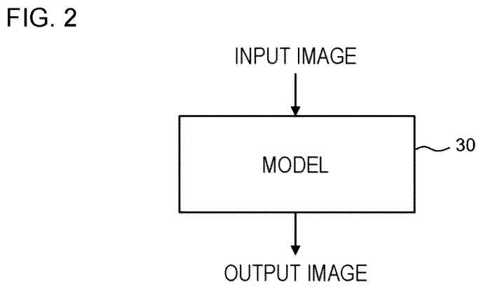

FIG. 2 is a diagram illustrating a model 30 generated by the model generation device 10 according to the present example embodiment. The model generation device 10 according to the present example embodiment is a device that generates the model 30 capable of increasing resolution of a radar image. The radar image is an image obtained by processing radar signal data obtained by a radar. Existing imaging processing can be used for processing to obtain the radar image from the radar signal data. An image is input to the model 30 as input data. The image input to the model 30 is also referred to as an input image. The input image is the radar image. An image is output from the model 30 as output data. The image output from the model 30 is also referred to as an output image. By using the model 30, the output image, higher in resolution than the input image, is obtained.

The model 30 includes a neural network. The model generation device 10 according to the present example embodiment generates the model 30 by performing machine learning using training data in which the first image and the second image are combined. Here, the second image is higher resolution than the first image. In the machine learning, the model generation device 10 uses the first image as input data to the model and the second image as ground truth data. However, the model 30 may be generated by a method other than the neural network.

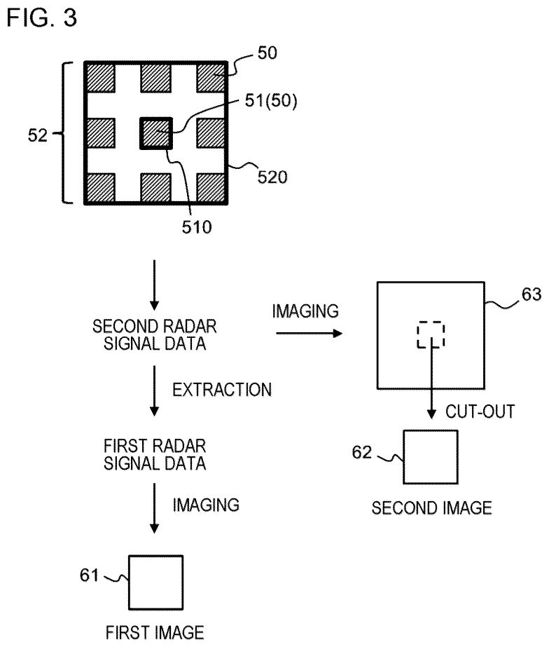

FIG. 3 is a diagram for describing a first image 61 and a second image 62 according to the present example embodiment. The first image 61 and the second image 62 are generated by using a second radar 52. Here, the second radar 52 includes a first radar 51 as a part of the second radar 52. In an example of FIG. 3, the second radar 52 includes a plurality of subsets 50. In the example of FIG. 3, the first radar 51 is one of the plurality of subsets 50 included in the second radar 52.

However, configurations of the second radar 52 and the first radar 51 and the relationship between the second radar 52 and the first radar 51 are not limited to the example of FIG. 3. For example, in the example of FIG. 3, the first radar 51 is the subset 50 located at the center of the second radar 52, but the first radar 51 may be the subset 50 located at another position. Although the first radar 51 includes one subset 50 in the example of FIG. 3, the first radar 51 may include two or more subsets 50. However, the first radar 51 does not include all the subsets 50 included in the second radar 52.

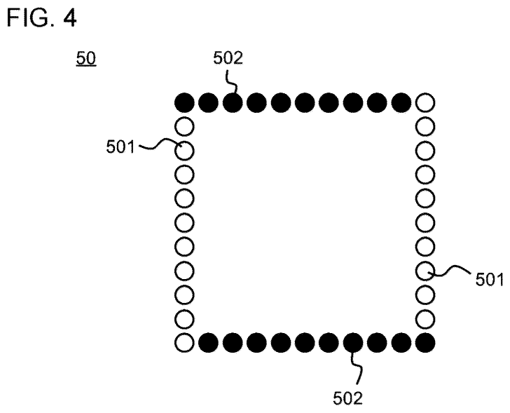

FIG. 4 is a diagram illustrating an antenna arrangement in one subset 50. In FIG. 4, a transmission antenna 501 is indicated by a white circle, and the reception antenna 502 is indicated by a black circle. The subset 50 includes a plurality of the transmission antennas 501 and a plurality of the reception antennas 502. The transmission antennas 501 and the reception antennas 502 are collectively referred to as antennas. In the subset 50, the plurality of antennas are arranged to draw a quadrangle. In this quadrangle, the plurality of antennas are arranged in such a way that one set of two opposing sides is drawn by rows of the transmission antennas 501 and the other set of two opposing sides is drawn by rows of the reception antennas 502.

The first radar 51 and the second radar 52 transmit and receive radio waves in a predetermined frequency band. The first radar 51 and the second radar 52 are, for example, radars of a stepped frequency continuous wave (SFCW) system. Alternatively, the first radar 51 and the second radar 52 may be radars of a frequency modulated continuous wave (FMCW) system. Frequencies of radio waves transmitted by the transmission antennas 501 change stepwise or continuously within the predetermined frequency band. In the subset 50, a distance between adjacent antennas is λ/2, for example, but not limited to λ/2. A wavelength relevant to the highest frequency of the frequency band of radio waves transmitted and received by the first radar 51 and the second radar 52 is denoted by λ. The antenna arrangement in the subset 50 is not limited to an example in FIG. 4.

The second radar 52 transmits and receives radio waves to generate the second radar signal data. The second radar signal data includes a plurality of pieces of received data based on signals received by the reception antennas 502. Specifically, the plurality of transmission antennas 501 transmit radio waves at different timings. All the reception antennas 502 included in the second radar 52 receive the radio waves transmitted from the transmission antennas 501 and reflected by a target. Each of the reception antennas 502 may also receive a radio wave transmitted from the transmission antenna 501 included in the subset 50 different from the subset 50 including the reception antenna 502 and reflected by the target. As a result, received data is obtained for all pairs of the transmission antenna 501 and the reception antenna 502 included in the second radar 52. The radar signal data of the second radar 52 includes all pieces of the received data.

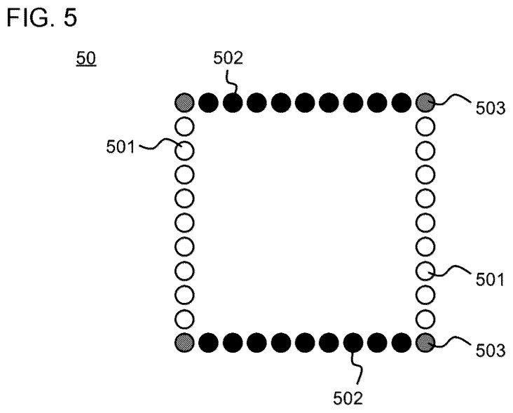

FIG. 5 is a diagram illustrating a first modified example of the antenna arrangement in one subset 50. In the first modified example, transmission/reception antennas 503 each having both a transmission function and a reception function are arranged at four corners, respectively. However, the transmission function and the reception function of the transmission/reception antenna 503 are not simultaneously operated. While the transmission/reception antenna 503 functions as a reception antenna, the transmission/reception antenna 503 does not function as a transmission antenna. While the transmission/reception antenna 503 functions as the transmission antenna, the transmission/reception antenna 503 does not function as the reception antenna.

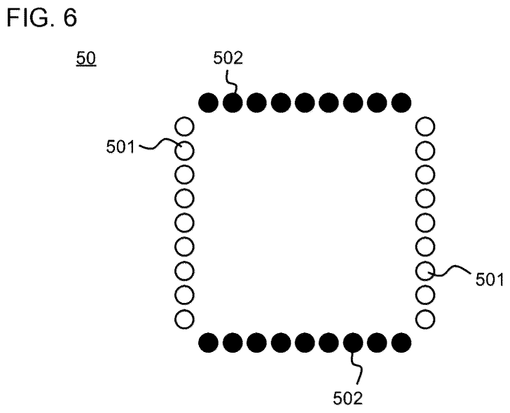

FIG. 6 is a diagram illustrating a second modified example of the antenna arrangement in one subset 50. In the second modified example, no antenna is arranged at four corners.

In any case of FIGS. 4 to 6, a direction in which antennas are arranged is not particularly limited. The reception antennas 502 may be arranged in the vertical direction, and the transmission antennas 501 may be arranged in the horizontal direction. Furthermore, the numbers of the reception antennas 502 and the transmission antennas 501 are not limited to the examples of FIGS. 4 to 6.

Returning to FIG. 3, the first image 61 and the second image 62 will be further described. As described above, the second radar signal data is signal data obtained by the second radar 52 including the first radar 51. The first radar signal data is obtained by extracting data relevant to signal data of the first radar 51 from the second radar signal data. It can be said that the second radar signal data is data measured simultaneously with the first radar signal data.

Specifically, received data, obtained as the reception antennas 502 included in the first radar 51 receive radio waves transmitted from the transmission antennas 501 included in the first radar 51 and reflected by the target, is extracted from the second radar signal data. Then, the first radar signal data including a plurality of pieces of the extracted received data is generated. The first radar signal data does not include received data of radio waves transmitted by the transmission antennas 501 not included in the first radar 51. Furthermore, the first radar signal data does not include received data of radio waves received by the reception antennas 502 not included in the first radar 51.

The first radar signal data includes signal data for the whole or only a part of the frequency band of radio waves transmitted and received by the second radar. That is, data for the entire frequency band of the second radar signal data may be extracted and used as the first radar signal data, or data in a part of the frequency band may be extracted and used as the first radar signal data. In the latter case, the first radar signal data does not include data other than the extracted data for the part of frequency band. In this manner, the frequency band of the second radar signal data may be wider than the frequency band of the first radar signal data. That is, the frequency band of the radio waves transmitted and received by the first radar 51 may be virtually narrower than the frequency band of radio waves transmitted and received by the second radar 52.

The first image 61 is an image generated by performing imaging processing on the first radar signal data.

An image 63 is obtained by similarly performing imaging processing on the second radar signal data. Since an aperture 520 of the second radar 52 is larger than an aperture 510 of the first radar 51, the image 63 has an angle of view larger than an angle of view of the first image 61. Since the number of antennas included in the second radar 52 is larger than the number of antennas included in the first radar 51, resolution of the image 63 is higher than resolution of the first image 61.

The second image 62 is an image obtained by cutting out a part of the image 63 generated using the second radar signal data. Specifically, the second image 62 is an image obtained by cutting out a region relevant to the first image 61 from the radar image 63 generated using the second radar signal data. A position and a size of the second image 62 cut out from the image 63 are determined based on a positional relationship and a size relationship of the aperture 510 of the first radar 51 with respect to the aperture 520 of the second radar 52. In this manner, the first image 61 and the second image 62 obtained by capturing the same target region can be obtained. In addition, the second image 62 that is higher in resolution than the first image 61 can be obtained.

The training data includes the first image 61 and the second image 62 obtained from the same second radar signal data.

By using such training data, the model 30 capable of increasing resolution of a radar image obtained by a radar with a small number of antennas can be obtained.

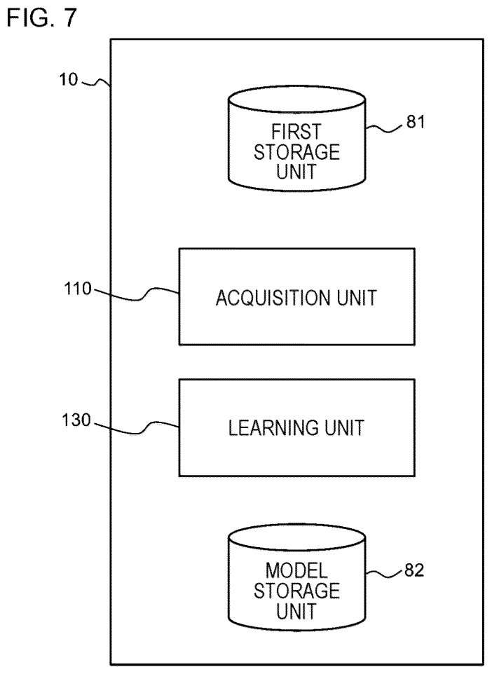

FIG. 7 is a diagram illustrating a functional configuration of the model generation device 10 according to the present example embodiment. In the example of FIG. 7, the model generation device 10 further includes an acquisition unit 110, a first storage unit 81, and a model storage unit 82. However, the first storage unit 81 may be provided outside the model generation device 10. The model storage unit 82 may be provided outside the model generation device 10.

The first storage unit 81 holds, for example, the training data obtained by combining the first image 61 and the second image 62. The training data can be prepared in advance and held in the first storage unit 81.

The model storage unit 82 holds information for configuring the model 30. The information for configuring the model 30 includes a plurality of parameters of the neural network.

The acquisition unit 110 of the model generation device 10 reads and acquires the training data, that is, a set of the first image 61 and the second image 62 from the first storage unit 81. However, the acquisition unit 110 may acquire the training data from another device. In that case, the first storage unit 81 is not necessarily provided.

The learning unit 130 updates the parameters held in the model storage unit 82 by performing machine learning using the training data acquired by the acquisition unit 110. The machine learning can be performed using existing techniques. For example, the learning unit 130 inputs the first image 61 to the model 30 and obtains an output image from the model 30. Then, a loss is calculated using the output image and the second image 62 included in the same training data as the first image 61 input to the model 30. Then, the parameters of the model 30 are updated in such a way as to reduce the loss.

The first storage unit 81 can hold a plurality of pieces of the training data. Then, the acquisition unit 110 can acquire the plurality of pieces of training data. The learning unit 130 repeats updating of the parameters using the plurality of pieces of training data. For example, the learning unit 130 repeats updating of the parameters until a predetermined end condition is satisfied. The predetermined end condition is, for example, at least one of a condition that the number of parameter updates becomes a predetermined number of times and a condition that the loss becomes smaller than a predetermined reference.

A hardware configuration of the model generation device 10 will be described below. Each of functional components (the acquisition unit 110 and the learning unit 130) of the model generation device 10 may be achieved by hardware (e.g., a hard-wired electronic circuit etc.) that achieves each of the functional components, or may be achieved by a combination of hardware and software (e.g., a combination of an electronic circuit and a program for controlling the electronic circuit etc.). Hereinafter, a case where each functional component of the model generation device 10 is achieved by a combination of hardware and software will be further described.

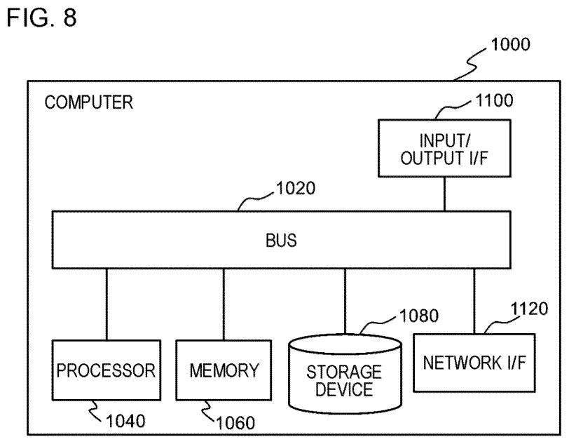

FIG. 8 is a diagram illustrating a computer 1000 for achieving the model generation device 10. The computer 1000 is any computer. For example, the computer 1000 is a system on chip (SoC), a personal computer (PC), a server machine, a tablet terminal, or a smartphone. The computer 1000 may be a dedicated computer designed to achieve the model generation device 10, or may be a general-purpose computer. Furthermore, the model generation device 10 may be achieved by one computer 1000 or may be achieved by a combination of a plurality of computers 1000.

The computer 1000 includes a bus 1020, a processor 1040, a memory 1060, a storage device 1080, an input/output interface 1100, and a network interface 1120. The bus 1020 is a data transmission path for the processor 1040, the memory 1060, the storage device 1080, the input/output interface 1100, and the network interface 1120 to transmit and receive data to and from each other. However, a method of connecting the processor 1040 and the like to each other is not limited to the bus connection. The processor 1040 is any of processors such as a central processing unit (CPU), a graphics processing unit (GPU), or a field-programmable gate array (FPGA). The memory 1060 is a main storage device achieved by using a random-access memory (RAM) or the like. The storage device 1080 is an auxiliary storage device achieved by using a hard disk, a solid state drive (SSD), a memory card, read only memory (ROM), or the like.

The input/output interface 1100 is an interface for connecting the computer 1000 and an input/output device. For example, an input device such as a keyboard and an output device such as a display are connected to the input/output interface 1100. A method of connecting the input/output interface 1100 to the input device or the output device may be a wireless connection or a wired connection.

The network interface 1120 is an interface for connecting the computer 1000 to a network. This communication network is, for example, a local area network (LAN) or a wide area network (WAN). A method of connecting the network interface 1120 to the network may be a wireless connection or a wired connection.

The storage device 1080 stores program modules that achieve the functional components of the model generation device 10. The processor 1040 reads and executes each of the program modules into the memory 1060, thereby achieving functions related to the program modules.

In a case where the first storage unit 81 is provided inside the model generation device 10, for example, the first storage unit 81 is achieved by using the storage device 1080. In a case where the model storage unit 82 is provided inside the model generation device 10, for example, the model storage unit 82 is achieved by using the storage device 1080.

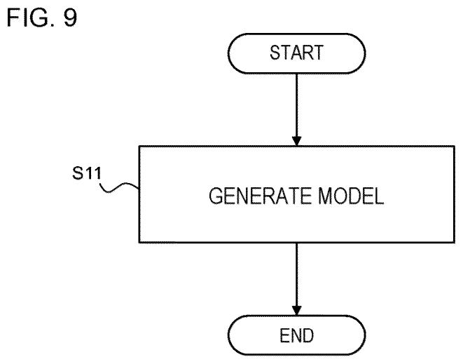

FIG. 9 is a diagram illustrating an outline of a model generation method according to the present example embodiment. In the model generation method according to the present example embodiment, one or more computers perform machine learning using the first image 61 and the second image 62 to generate the model 30 (S11). The first image 61 is an image generated using first radar signal data. The second image 62 is an image generated using second radar signal data. The first radar signal data is a signal extracted from the second radar signal data.

As described above, according to the present example embodiment, the learning unit 130 generates a model by performing the machine learning using the first image 61 and the second image 62. Therefore, the model 30 capable of obtaining a high-resolution image is obtained regardless of an antenna configuration of a radar.

### First Modification

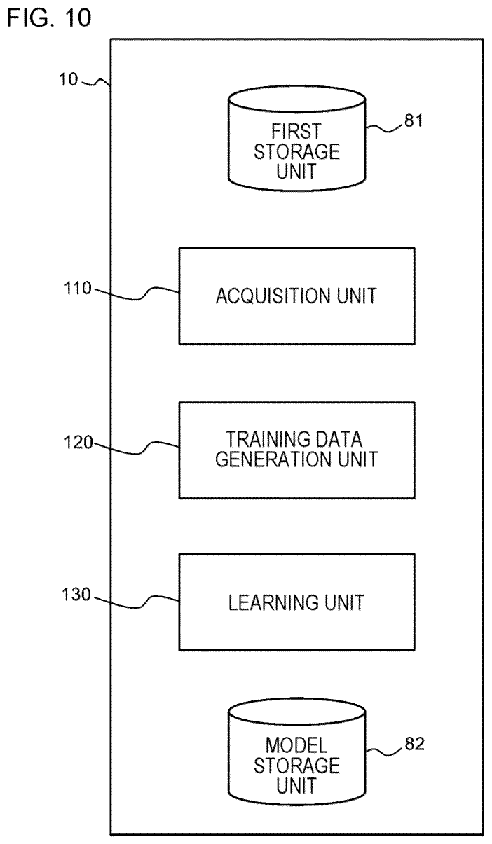

FIG. 10 is a diagram illustrating a functional configuration of the model generation device 10 according to a first modification. The model generation device 10 according to the present modification is identical to the model generation device 10 according to the first example embodiment except for points described below.

In the present modification, the model generation device 10 includes a training data generation unit 120. The first storage unit 81 holds data for generating training data in advance. That is, the first storage unit 81 holds data for obtaining the first image 61 and the second image 62 in advance. The acquisition unit 110 according to the present modification reads and acquires the data for generating training data from the first storage unit 81. Then, the training data generation unit 120 generates training data (a set of the first image 61 and the second image 62) using the data acquired by the acquisition unit 110. The learning unit 130 generates the model 30 in the same manner as in the first example embodiment using the training data generated by the training data generation unit 120.

The data for generating training data is at least one of second radar signal data, first radar signal data, and the image 63. That is, the data for generating training data may be only the second radar signal data, may be a combination of the second radar signal data and the first radar signal data, or may be a combination of the second radar signal data and the image 63. The data for generating training data may be a combination of the first radar signal data and the image 63. Alternatively, the data for generating training data may be a combination of one of the first image 61 and the second image 62 and data for generating the other of the first image 61 and the second image 62.

As the second radar signal data, data obtained from the second radar 52 can be held in the first storage unit 81 in advance. The first radar signal data and the image 63 can be generated and prepared by another information processing device or the like, and held in the first storage unit 81 in advance.

However, the acquisition unit 110 may acquire the data for generating training data from a radar or another information processing device. In that case, the first storage unit 81 is not necessarily provided.

The acquisition unit 110 and the training data generation unit 120 according to the present modification will be described in detail below.

The acquisition unit 110 acquires the data for generating training data.

In a case where the acquisition unit 110 acquires the second radar signal data, the training data generation unit 120 generates at least one of the first image 61 and the second image 62 using the second radar signal data.

Specifically, the training data generation unit 120 extracts the first radar signal data from the second radar signal data as described above. The training data generation unit 120 can generate the first image 61 by performing imaging processing on the first radar signal data.

The training data generation unit 120 also generates the image 63 by performing imaging processing on the second radar signal data, and cuts out the second image 62 from the image 63. In this manner, the second image 62 can be generated.

In a case where the acquisition unit 110 acquires the first radar signal data, the training data generation unit 120 generates the first image 61 by performing imaging processing on the first radar signal data.

In a case where the acquisition unit 110 acquires the image 63, the training data generation unit 120 cuts out the second image 62 from the image 63 to generate the second image 62.

In this manner, the training data generation unit 120 can generate the training data.

The first storage unit 81 can hold a plurality of pieces of the data for generating training data. Then, the acquisition unit 110 can acquire the plurality of pieces of data for generating training data. The training data generation unit 120 generates a plurality of pieces of the training data. Then, the learning unit 130 repeats updating of parameters using the plurality of pieces of training data as in the first example embodiment.

A hardware configuration of a computer that achieves the model generation device 10 according to the present modification is represented by, for example, FIG. 8, similarly to the model generation device 10. However, the storage device 1080 of the computer 1000 that achieves the model generation device 10 according to the present modification further stores a program module that achieves a function of the training data generation unit 120.

According to the present modification, operations and effects similar to those of the first example embodiment are obtained.

### Second Example Embodiment

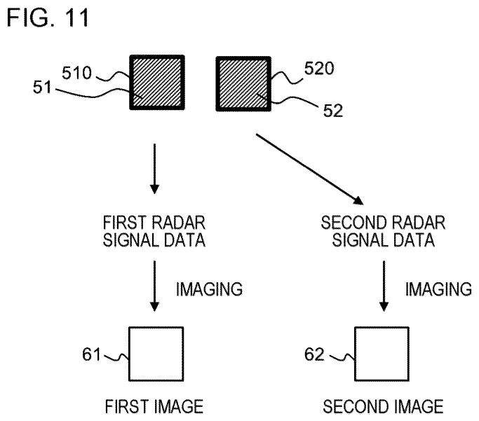

An outline of the model generation device 10 according to a second example embodiment is illustrated in FIG. 1 similarly to the first example embodiment. FIG. 11 is a diagram for describing the first image 61 and the second image 62 according to the present example embodiment. The model generation device 10 according to the present example embodiment is identical to the model generation device 10 according to the first example embodiment except for points described below.

The model generation device 10 according to the present example embodiment includes the learning unit 130. The learning unit 130 generates the model 30 by performing machine learning using the first image 61 and the second image 62. The first image 61 is an image generated using first radar signal data obtained by the first radar 51. The second image 62 is an image generated using second radar signal data obtained by the second radar 52. In the present example embodiment, a center frequency of a frequency band of radio waves transmitted and received by the second radar 52 is higher than a center frequency of a frequency band of radio waves transmitted and received by the first radar 51. Detailed description will be given below.

In the present example embodiment, the first radar 51 is not included in the second radar 52. In an example of FIG. 11, the aperture 510 of the first radar 51 and the aperture 520 of the second radar 52 are provided independently of each other. In the present example embodiment, a size of the aperture 520 of the second radar 52 may be the same as a size of the aperture 510 of the first radar 51. In this case, an angle of view of the first image 61 and an angle of view of the second image 62 are the same.

The number of antennas included in the second radar 52 may be larger than the number of antennas included in the first radar 51. At least a part of the aperture 510 of the first radar 51 may overlap the aperture 520 of the second radar 52. That is, some of the antennas of the first radar 51 may also serve as antennas of the second radar 52.

In the present example embodiment, the radio waves transmitted and received by the second radar 52 have a higher frequency than the radio waves transmitted and received by the first radar 51. Therefore, the second image 62 is higher in resolution than the first image 61. Specifically, as described above, the center frequency of the frequency band of the radio waves transmitted and received by the second radar 52 is higher than the center frequency of the frequency band of the radio waves transmitted and received by the first radar 51. Note that a center frequency is an arithmetic mean of the highest frequency and the lowest frequency in a frequency band.

As long as the second image 62 is higher in resolution than the first image 61, the relationship between a bandwidth of the frequency band of the radio waves transmitted and received by the first radar 51 and a bandwidth of the frequency band of the radio waves transmitted and received by the second radar 52 is not particularly limited. That is, the bandwidth of the frequency band of the radio waves transmitted and received by the first radar 51 may be wider or narrower than the bandwidth of the frequency band of the radio waves transmitted and received by the second radar 52. Alternatively, the bandwidth of the frequency band of the radio waves transmitted and received by the first radar 51 may be the same as the bandwidth of the frequency band of the radio waves transmitted and received by the second radar 52.

The first image 61 is generated by performing imaging processing on the first radar signal data obtained by the first radar 51. The second image 62 is generated by performing imaging processing on the second radar signal data obtained by the second radar 52.

The first radar signal data and the second radar signal data are obtained by measuring substantially the same target (region) under substantially the same condition by the first radar 51 and the second radar 52. As a result, the first image 61 and the second image 62, which are related to each other and have correlation, are obtained. For example, the first image 61 and the second image 62 obtained by capturing substantially the same target region can be obtained. For example, the first radar 51 and the second radar 52 can be provided on the same board, and measurement conditions and the like can be set and controlled. In order to avoid interference, measurement timing of the first radar 51 may be slightly shifted from measurement timing of the second radar 52. Alternatively, a frequency component that causes interference may be removed from a signal received by the reception antenna 502 using a filter or the like. That is, a frequency component of the second radar 52 is removed from a signal received by the first radar 51, and a frequency component of the first radar 51 is removed from a signal received by the second radar 52. In this case, the frequency band of the first radar 51 and the frequency band of the second radar 52 may not overlap.

Training data includes the first image 61 and the second image 62 that are related to each other and have correlation. That is, the training data includes the first image 61 and the second image 62 obtained by measuring substantially the same target (region) under substantially the same condition by the first radar 51 and the second radar 52.

By using such training data, the model 30 capable of increasing resolution of a radar image obtained by a radar with a small number of antennas can be obtained.

A functional configuration of the model generation device 10 according to the present example embodiment is illustrated in FIG. 7 similarly to the first example embodiment. Similarly to the first example embodiment, the acquisition unit 110 of the model generation device 10 reads and acquires the training data, that is, a set of the first image 61 and the second image 62 from the first storage unit 81. The learning unit 130 updates parameters of the model 30 held in the model storage unit 82 by performing machine learning using the training data acquired by the acquisition unit 110.

Similarly to the first example embodiment, the first storage unit 81 can hold a plurality of pieces of the training data. Then, the acquisition unit 110 can acquire the plurality of pieces of training data. The learning unit 130 repeats updating of the parameters using the plurality of pieces of training data.

An outline of a model generation method according to the present example embodiment is illustrated in FIG. 9 similarly to the first example embodiment. In the model generation method according to the present example embodiment, one or more computers perform machine learning using the first image 61 and the second image 62 to generate a model (S11). The first image 61 is an image generated using first radar signal data obtained by the first radar 51. The second image 62 is an image generated using second radar signal data obtained by the second radar 52. A center frequency of a frequency band of radio waves transmitted and received by the second radar 52 is higher than a center frequency of a frequency band of radio waves transmitted and received by the first radar 51.

According to the present example embodiment, operations and effects similar to those of the first example embodiment are obtained.

### Second Modification

A functional configuration of the model generation device 10 according to a second modification is illustrated in FIG. 10 similarly to the first modification. The model generation device 10 according to the present modification is identical to the model generation device 10 according to the second example embodiment except for points described below.

In the present modification, the model generation device 10 includes the training data generation unit 120. The first storage unit 81 holds data for generating training data in advance. That is, the first storage unit 81 holds data for obtaining the first image 61 and the second image 62 in advance. The acquisition unit 110 according to the present modification reads and acquires the data for generating training data from the first storage unit 81. Then, the training data generation unit 120 generates training data using the data acquired by the acquisition unit 110. The learning unit 130 generates the model 30 in the same manner as in the second example embodiment using the training data generated by the training data generation unit 120.

The data for generating training data is first radar signal data and second radar signal data. Alternatively, the data for generating training data may be a combination of one of the first image 61 and the second image 62 and data for generating the other of the first image 61 and the second image 62.

As the first radar signal data, data obtained from the first radar 51 can be held in the first storage unit 81 in advance. As the second radar signal data, data obtained from the second radar 52 can be held in the first storage unit 81 in advance.

However, the acquisition unit 110 may acquire the data for generating training data directly from a radar. In that case, the first storage unit 81 is not necessarily provided.

The acquisition unit 110 and the training data generation unit 120 according to the present modification will be described in detail below.

In a case where the acquisition unit 110 acquires the first radar signal data, the training data generation unit 120 generates the first image 61 by performing imaging processing on the first radar signal data. In a case where the acquisition unit 110 acquires the second radar signal data, the training data generation unit 120 generates the second image 62 by performing imaging processing on the second radar signal data.

In this manner, the training data generation unit 120 can generate the training data.

The first storage unit 81 can hold a plurality of pieces of the data for generating training data. Then, the acquisition unit 110 can acquire the plurality of pieces of data for generating training data. The training data generation unit 120 generates a plurality of pieces of the training data. Then, the learning unit 130 repeats updating of parameters using the plurality of pieces of training data as in the second example embodiment.

A hardware configuration of a computer that achieves the model generation device 10 according to the present modification is represented by, for example, FIG. 8, similarly to the model generation device 10. However, the storage device 1080 of the computer 1000 that achieves the model generation device 10 according to the present modification further stores a program module that achieves a function of the training data generation unit 120.

According to the present modification, operations and effects similar to those of the first example embodiment are obtained.

### Third Example Embodiment

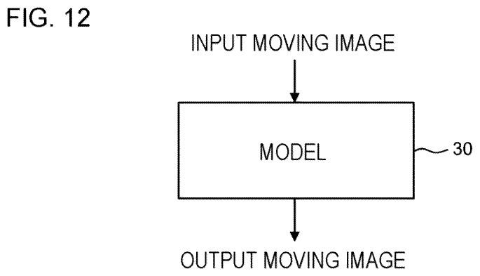

FIG. 12 is a diagram illustrating the model 30 generated by the model generation device 10 according to a third example embodiment. The model generation device 10 according to the present example embodiment is the same as the model generation device 10 according to at least one of the first and second example embodiments, the first modification, and the second modification, except for points described below.

The learning unit 130 according to the present example embodiment generates the model 30 by performing machine learning using a plurality of first images 61 that are a plurality of moving image frames and a plurality of second images 62 that are a plurality of moving image frames. Detailed description will be given below.

In the present example embodiment, a moving image is input to the model 30 as input data. Furthermore, a moving image is output from the model 30 as output data. In other words, a plurality of time-series images, that is, a plurality of moving image frames are input to the model 30 as input data. The moving image input to the model 30 is also referred to as an input moving image. The input moving image is a moving image including a radar image. The model 30 outputs a plurality of time-series images, that is, a plurality of moving image frames as output data. The moving image output from the model 30 is also referred to as an output moving image. By using the model 30, the output moving image, higher in resolution than the input moving image, is obtained. In the model 30 according to the present example embodiment, an increase in resolution of each image is affected by images before and after the image. Therefore, the resolution of the moving image can be increased more accurately.

Also in the present example embodiment, the model 30 includes a neural network. The model generation device 10 according to the present example embodiment generates the model 30 by performing machine learning using training data in which a first moving image and a second moving image are combined. The first moving image is a moving image including the plurality of first images 61. The second moving image is a moving image including the plurality of second images 62. In the machine learning, the model generation device 10 uses the first moving image as input data to the model and the second moving image as ground truth data.

Each of the first images 61 and each of the second images 62 according to the present example embodiment are the same as those described in the first or second example embodiment. The plurality of first images 61 and the plurality of second images 62 are obtained by repeating measurement with the first radar 51 and the second radar 52. That is, the first moving image and the second moving image are obtained.

A functional configuration of the model generation device 10 according to the present example embodiment is illustrated in FIG. 7 similarly to the first and second example embodiments. Alternatively, the functional configuration of the model generation device 10 according to the present example embodiment is illustrated in FIG. 10 similarly to the first modification and the second modification.

The acquisition unit 110 of the model generation device 10 according to the present example embodiment acquires the training data in the same manner as in the first and second example embodiments. Alternatively, the acquisition unit 110 acquires data for generating training data, and the training data generation unit 120 generates the training data in the same manner as in the first modification and the second modification.

The learning unit 130 updates parameters held in the model storage unit 82 by performing machine learning using the training data. The machine learning can be performed using existing techniques. For example, the learning unit 130 inputs the first moving image to the model 30 and obtains the output moving image from the model 30. Then, a loss is calculated using the output moving image and the second moving image included in the same training data as the first moving image input to the model 30. Then, the parameters of the model 30 are updated in such a way as to reduce the loss. Furthermore, the learning unit 130 can repeat updating of the parameters using a plurality of pieces of the training data.

Next, operations and effects of the present example embodiment will be described. In the present example embodiment, operations and effects similar to those of the first example embodiment are obtained. In addition, the model 30 capable of obtaining a high-resolution moving image is obtained regardless of an antenna configuration of a radar.

### Fourth Example Embodiment

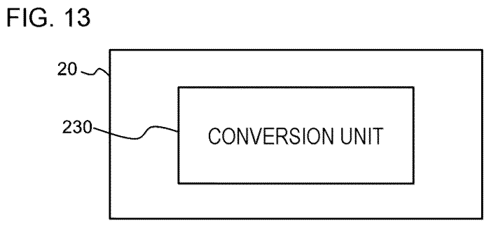

FIG. 13 is a diagram illustrating an outline of a conversion device 20 according to a fourth example embodiment. The conversion device 20 according to the present example embodiment includes a conversion unit 230. The conversion unit 230 converts a target image using the model 30. The model 30 used by the conversion unit 230 is the model 30 generated by the model generation device 10 according to at least one of the first to third example embodiments, the first modification, and the second modification. Detailed description will be given below.

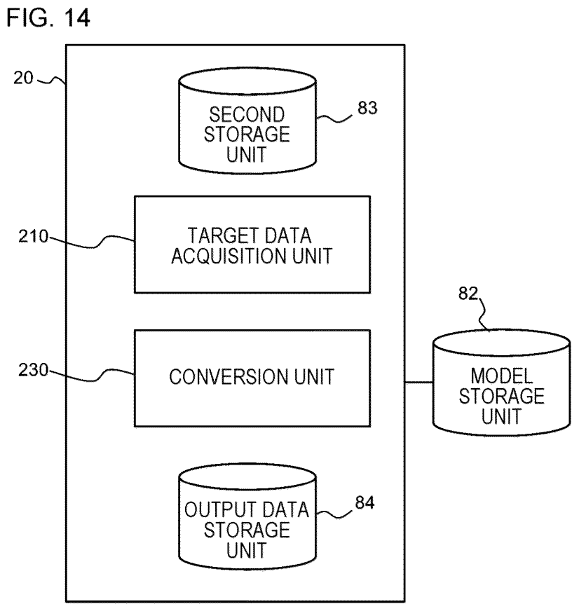

FIG. 14 is a diagram illustrating a functional configuration of the conversion device 20 according to the present example embodiment. In an example of FIG. 14, the conversion device 20 further includes a target data acquisition unit 210, a second storage unit 83, and an output data storage unit 84. However, the second storage unit 83 may be provided outside the conversion device 20. The output data storage unit 84 may be provided outside the conversion device 20.

The second storage unit 83 holds, for example, a target image. The target image is, for example, a radar image obtained by a third radar. The third radar may have the same configuration (number of antennas, antenna arrangement, and the like) as the first radar 51. The third radar may be the first radar 51 itself or a radar different from the first radar 51. The target image is an image obtained by performing imaging processing on third laser signal data obtained by the third radar. Measurement conditions (a frequency band, measurement time, and the like) for obtaining the third radar signal data by the third radar may be the same as measurement conditions for obtaining the first radar signal data by the first radar 51. The frequency band of the third radar signal data may be the same as the frequency band of the first radar signal data.

The second storage unit 83 may hold data for generating the target image instead of holding the target image. The data for generating the target image is, for example, the third radar signal data.

The target data acquisition unit 210 of the conversion device 20 acquires the target image or the data for generating the target image from the second storage unit 83. However, the target data acquisition unit 210 may acquire the target image or the data for generating the target image from the third radar or another information processing device. In that case, the second storage unit 83 is not necessarily provided.

In a case where the target data acquisition unit 210 acquires the data for generating the target image, the conversion unit 230 generates the target image by performing imaging processing on the data.

The conversion unit 230 inputs the target image to the model 30. The conversion unit 230 can access the model storage unit 82, and can use the model 30 held in the model storage unit 82. The model storage unit 82 may be provided in the conversion device 20. The conversion unit 230 can obtain an output image of the model 30. The conversion unit 230 can obtain an image higher in resolution than the input target image as the output image.

In a case where the model 30 can receive input of a moving image as described in the third example embodiment, the conversion unit 230 may obtain a plurality of target images, which are a plurality of moving image frames, and input the target images to the model 30. Then, the conversion unit 230 can obtain a moving image higher in resolution than the input moving image as an output moving image.

The conversion unit 230 causes, for example, the output data storage unit 84 to hold the obtained output image or output moving image. In addition, the conversion unit 230 may output the output image or the output moving image to another device.

For example, in order for downsizing, a target image obtained by a radar having a small aperture size and a small number of antennas can be converted by the conversion device 20 to obtain a high-resolution image. Furthermore, in order for cost reduction, a target image obtained by a radar with a reduced number of antennas can be converted by the conversion device 20 to obtain a high-resolution image.

A hardware configuration of a computer that achieves the conversion device 20 is represented by, for example, FIG. 8, similarly to the model generation device 10. However, the storage device 1080 of the computer 1000 that achieves the conversion device 20 of the present example embodiment stores program modules that achieve functions of functional components (the target data acquisition unit 210 and the conversion unit 230) of the conversion device 20 of the present example embodiment.

Furthermore, in a case where the second storage unit 83 is provided inside the conversion device 20, for example, the second storage unit 83 is achieved by using the storage device 1080 of the computer 1000 that achieves the conversion device 20. In a case where the output data storage unit 84 is provided inside the conversion device 20, for example, the output data storage unit 84 is achieved by using the storage device 1080 of the computer 1000 that achieves the conversion device 20. In a case where the model storage unit 82 is provided inside the conversion device 20, for example, the model storage unit 82 is achieved by using the storage device 1080 of the computer 1000 that achieves the conversion device 20.

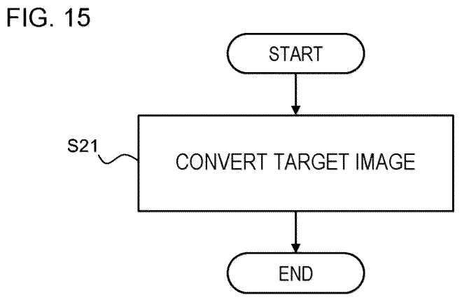

FIG. 15 is a diagram illustrating an outline of a conversion method according to the present example embodiment. In the conversion method according to the present example embodiment, one or more computers convert a target image using the model 30 (S21). The model 30 is the model 30 generated by the model generation device 10 according to at least one of the first to third example embodiments, the first modification, and the second modification.

As described above, according to the present example embodiment, the conversion unit 230 converts the target image using the model 30. Therefore, the target image can be converted into a high-resolution image.

Although the example embodiments of the present invention have been described above with reference to the drawings, these are examples of the present invention, and various configurations other than the above can be used.

Furthermore, an execution order of steps executed in each example embodiment is not limited to the described order. In each example embodiment, the order of the steps can be changed as long as nothing interferes in terms of content. The above-described example embodiments can be combined unless otherwise contradicted in content.

Some or all of the example embodiments described above may be described as the following Supplementary Notes, but are not limited to the following.

1-1. A model generation apparatus including a learning means for generating a model by performing machine learning using a first image and a second image,
in which the first image is an image generated using first radar signal data,
the second image is an image generated using second radar signal data, and
the first radar signal data is a signal extracted from the second radar signal data.

1-2. The model generation apparatus according to 1-1., in which
the second radar signal data is signal data obtained by a second radar including a first radar, and
the first radar signal data is signal data obtained by extracting data relevant to signal data of the first radar from the second radar signal data.

1-3. The model generation apparatus according to 1-2., in which
an aperture of the second radar is larger than an aperture of the first radar.

1-4. The model generation apparatus according to 1-2. or 1-3., in which
the first radar signal data includes signal data for the whole or only a part of a frequency band of radio waves transmitted and received by the second radar.

1-5. The model generation apparatus according to any one of 1-1. to 1-4., in which
the second image is an image obtained by cutting out a part of the image generated using the second radar signal data.

1-6. The model generation apparatus according to 1-5., in which
the second image is an image obtained by cutting out a region relevant to the first image from the image generated using the second radar signal data.

1-7. The model generation apparatus according to any one of 1-1. to 1-6., in which
the second image is higher in resolution than the first image.

1-8. The model generation apparatus according to any one of 1-1. to 1-7., in which
the learning means generates a model by performing machine learning using a plurality of the first images that are a plurality of moving image frames and a plurality of the second images that are a plurality of moving image frames.

2-1. A model generation apparatus including a learning means for generating a model by performing machine learning using a first image and a second image,
in which the first image is an image generated using first radar signal data obtained by a first radar,
the second image is an image generated using second radar signal data obtained by a second radar, and
a center frequency of a frequency band of radio waves transmitted and received by the second radar is higher than a center frequency of a frequency band of radio waves transmitted and received by the first radar.

2-2. The model generation apparatus according to 2-1., in which
an aperture size of the second radar is the same as an aperture size of the first radar.

2-3. The model generation apparatus according to 2-1. or 2-2., in which
the second image is higher in resolution than the first image.

2-4. The model generation apparatus according to any one of 2-1. to 2-3., in which
the learning means generates a model by performing machine learning using a plurality of the first images that are a plurality of moving image frames and a plurality of the second images that are a plurality of moving image frames.

3-1. A conversion apparatus including a conversion means for converting a target image using the model generated by the model generation apparatus according to any one of 1-1. to 1-8.

3-2. A conversion apparatus including a conversion means for converting a target image using the model generated by the model generation apparatus according to any one of 1-2. to 1-4.

3-3. A conversion apparatus including a conversion means for converting a target image using the model generated by the model generation apparatus according to any one of 2-1. to 2-4.

3-4. The conversion apparatus according to 3-2. or 3-3., in which
the target image is an image obtained by a radar having the same configuration as the first radar.

4-1. A model generation method including generating, by one or more computers, a model by performing machine learning using a first image and a second image,
in which the first image is an image generated using first radar signal data,
the second image is an image generated using second radar signal data, and
the first radar signal data is a signal extracted from the second radar signal data.

4-2. The model generation method according to 4-1., in which
the second radar signal data is signal data obtained by a second radar including a first radar, and
the first radar signal data is signal data obtained by extracting data relevant to signal data of the first radar from the second radar signal data.

4-3. The model generation method according to 4-2., in which
an aperture of the second radar is larger than an aperture of the first radar.

4-4. The model generation method according to 4-2. or 4-3., in which
the first radar signal data includes signal data for the whole or only a part of a frequency band of radio waves transmitted and received by the second radar.

4-5. The model generation method according to any one of 4-1. to 4-4., in which
the second image is an image obtained by cutting out a part of the image generated using the second radar signal data.

4-6. The model generation method according to 4-5., in which
the second image is an image obtained by cutting out a region relevant to the first image from the image generated using the second radar signal data.

4-7. The model generation method according to any one of 4-1. to 4-6., in which
the second image is higher in resolution than the first image.

4-8. The model generation method according to any one of 4-1. to 4-7., in which
the one or more computers generate the model by performing machine learning using a plurality of the first images that are a plurality of moving image frames and a plurality of the second images that are a plurality of moving image frames.

5-1. A model generation method including generating, by one or more computers, a model by performing machine learning using a first image and a second image,
in which the first image is an image generated using first radar signal data obtained by a first radar,
the second image is an image generated using second radar signal data obtained by a second radar, and
a center frequency of a frequency band of radio waves transmitted and received by the second radar is higher than a center frequency of a frequency band of radio waves transmitted and received by the first radar.

5-2. The model generation method according to 5-1., in which
an aperture size of the second radar is the same as an aperture size of the first radar. 5-3. The model generation method according to 5-1. or 5-2., in which
the second image is higher in resolution than the first image.

5-4. The model generation method according to any one of 5-1. to 5-3., in which
the one or more computers generate the model by performing machine learning using a plurality of the first images that are a plurality of moving image frames and a plurality of the second images that are a plurality of moving image frames.

6-1. A conversion method including converting, by one or more computers, a target image using the model generated by the model generation apparatus according to any one of 1-1. to 1-8.

6-2. A conversion method including converting, by one or more computers, a target image using the model generated by the model generation apparatus according to any one of 1-2. to 1-4.

6-3. A conversion method including converting, by one or more computers, a target image using the model generated by the model generation apparatus according to any one of 2-1. to 2-4.

6-4. The conversion method according to 6-2. or 6-3., in which
the target image is an image obtained by a radar having the same configuration as the first radar.

7-1. A program causing a computer to function as a learning means for generating a model by performing machine learning using a first image and a second image,
in which the first image is an image generated using first radar signal data,
the second image is an image generated using second radar signal data, and
the first radar signal data is a signal extracted from the second radar signal data.

7-2. The program according to 7-1., in which
the second radar signal data is signal data obtained by a second radar including a first radar, and
the first radar signal data is signal data obtained by extracting data relevant to signal data of the first radar from the second radar signal data.

7-3. The program according to 7-2., in which
an aperture of the second radar is larger than an aperture of the first radar.

7-4. The program according to 7-2. or 7-3., in which
the first radar signal data includes signal data for the whole or only a part of a frequency band of radio waves transmitted and received by the second radar.

7-5. The program according to any one of 7-1. to 7-4., in which
the second image is an image obtained by cutting out a part of the image generated using the second radar signal data.

7-6. The program according to 7-5., in which
the second image is an image obtained by cutting out a region relevant to the first image from the image generated using the second radar signal data.

7-7. The program according to any one of 7-1. to 7-6., in which
the second image is higher in resolution than the first image.

7-8. The program according to any one of 7-1. to 7-7., in which
the learning means generates a model by performing machine learning using a plurality of the first images that are a plurality of moving image frames and a plurality of the second images that are a plurality of moving image frames.

8-1. A program causing a computer to function as a learning means for generating a model by performing machine learning using a first image and a second image,
in which the first image is an image generated using first radar signal data obtained by a first radar,
the second image is an image generated using second radar signal data obtained by a second radar, and
a center frequency of a frequency band of radio waves transmitted and received by the second radar is higher than a center frequency of a frequency band of radio waves transmitted and received by the first radar.

8-2. The program according to 8-1., in which
an aperture size of the second radar is the same as an aperture size of the first radar.

8-3. The program according to 8-1. or 8-2., in which
the second image is higher in resolution than the first image.

8-4. The program according to any one of 8-1. to 8-3., in which
the learning means generates a model by performing machine learning using a plurality of the first images that are a plurality of moving image frames and a plurality of the second images that are a plurality of moving image frames.

9-1. A program causing a computer to function as a conversion means for converting a target image using the model generated by the model generation apparatus according to any one of 1-1. to 1-8.

9-2. A program causing a computer to function as a conversion means for converting a target image using the model generated by the model generation apparatus according to any one of 1-2. to 1-4.

9-3. A program causing a computer to function as a conversion means for converting a target image using the model generated by the model generation apparatus according to any one of 2-1. to 2-4.

9-4. The program according to 9-2. or 9-3., in which
the target image is an image obtained by a radar having the same configuration as the first radar.

10. A computer-readable recording medium on which the program according to any one of 7-1. to 7-8. is recorded.

11. A computer-readable recording medium on which the program according to any one of 8-1. to 8-4. is recorded.

12. A computer-readable recording medium on which the program according to any one of 9-1. to 9-4. is recorded.

This application is based upon and claims the benefit of priority from Japanese patent application No. 2023-095343, filed on Jun. 9, 2023, the disclosure of which is incorporated herein in its entirety by reference.

### REFERENCE SIGNS LIST

10 model generation device
20 conversion device
30 model
50 subset
51 first radar
52 second radar
61 first image
62 second image
81 first storage unit
82 model storage unit
83 second storage unit
84 output data storage unit
110 acquisition unit
120 training data generation unit
130 learning unit
210 target data acquisition unit
230 conversion unit
501 transmission antenna
502 reception antenna
503 transmission/reception antenna
510, 520 aperture
1000 computer

What is claimed is:

1. A model generation apparatus comprising:
at least one memory storing instructions; and
at least one processor configured to execute the instructions to perform operations comprising:
acquiring a first image and a second image; and
generating a model by performing machine learning using a the first image and the second image,
wherein the first image is an image generated using first radar signal data,
the second image is an image generated using second radar signal data, and
the first radar signal data is a signal extracted from the second radar signal data.

2. The model generation apparatus according to claim 1, wherein
the second radar signal data is signal data obtained by a second radar including a first radar, and
the first radar signal data is signal data obtained by extracting data relevant to signal data of the first radar from the second radar signal data.

3. The model generation apparatus according to claim 2, wherein
an aperture of the second radar is larger than an aperture of the first radar.

4. The model generation apparatus according to claim 3, wherein
the first radar signal data includes signal data for a whole or only a part of a frequency band of radio waves transmitted and received by the second radar.

5. The model generation apparatus according to claim 1, wherein
the second image is an image obtained by cutting out a part of the image generated using the second radar signal data.

6. The model generation apparatus according to claim 5, wherein
the second image is an image obtained by cutting out a region relevant to the first image from the image generated using the second radar signal data.

7. The model generation apparatus according to claim 1, wherein
the second image is higher in resolution than the first image.

8. The model generation apparatus according to claim 1, wherein
generating the model comprises generating the model by performing machine learning using a plurality of the first images that are a plurality of moving image frames and a plurality of the second images that are a plurality of moving image frames.

9. A conversion apparatus comprising:
at least one memory storing instructions; and
at least one processor configured to execute the instructions to perform operations comprising:
acquiring a target image or data for generating the target image; and
converting a target image using the model generated by the model generation apparatus according to claim 1.

10. A model generation method executed by one or more computers, the model generation method comprising:
acquiring a first image and a second image; and
generating a model by performing machine learning using the first image and the second image,
wherein the first image is an image generated using first radar signal data,
the second image is an image generated using second radar signal data, and
the first radar signal data is a signal extracted from the second radar signal data.

11. The model generation method according to claim 10, wherein
the second radar signal data is signal data obtained by a second radar including a first radar, and
the first radar signal data is signal data obtained by extracting data relevant to signal data of the first radar from the second radar signal data.

12. The model generation method according to claim 11, wherein
an aperture of the second radar is larger than an aperture of the first radar.

13. The model generation method according to claim 11, wherein
the first radar signal data includes signal data for a whole or only a part of a frequency band of radio waves transmitted and received by the second radar.

14. The model generation method according to claim 10, wherein
the second image is an image obtained by cutting out a part of the image generated using the second radar signal data.

15. The model generation method according to claim 14, wherein
the second image is an image obtained by cutting out a region relevant to the first image from the image generated using the second radar signal data.

16. The model generation method according to claim 10, wherein
the second image is higher in resolution than the first image.

17. The model generation method according to claim 10, wherein
generating the model comprises generating the model by performing machine learning using a plurality of the first images that are a plurality of moving image frames and a plurality of the second images that are a plurality of moving image frames.

18.-19. (canceled)
